(19) United States
(12) Patent Application Publication
(10) Pub. No.: US 2005/0025505 A1
(43) Pub. Date: Feb. 3, 2005

(54) Converting signals in passive optical networks

(76) Inventors: Alexander Soto, San Diego, CA (US); Walter Soto, San Clemente, CA (US)

Correspondence Address: FISH & RICHARDSON P.C., 3300 DAIN RAUSCHER PLAZA, MINNEAPOLIS, MN, 55402, US

(21) Appl. No.: 10/867,107

(22) Filed: Jun. 14, 2004

Related U.S. Application Data
(60) Provisional application No. 60/477,860, filed on Jun. 12, 2003.

(51) Int. Cl. H04B 10/06

(52) U.S. Cl. 398/214

(57) ABSTRACT

A converter includes an optical fiber input port; an optical detector configured to receive an optical signal over the optical fiber input port and generate a first electrical signal carrying information; and a mixer in electrical communication with the optical detector configured to mix the first electrical signal with a radio frequency carrier wave producing a second electrical signal for transmission by an antenna. The second electrical signal carries the same information as the first electrical signal.

### CROSS-REFERENCE TO RELATED APPLICATIONS

This application claims the benefit of U.S. Provisional Application No. 60/477,860 filed Jun. 12, 2003, incorporated herein by reference.

### FIELD OF THE INVENTION

The invention relates to communications systems.

### BACKGROUND OF THE INVENTION

Incumbent Local Exchange Carriers (ILECs), Competitive Local Exchange Carriers (CLECs) and Service Providers strive to deploy the most cost effective networks possible that provide broadband service links. Cost effectiveness is a relative term often measured by comparing the cost of equipment and material (also known as Capital Expenses CAPEX), the cost of service maintenance and operations (also known as Operational Expenses OPEX) and the cost of missed revenue generating opportunity due to deployment delays of alternative and competing network solutions. These cost comparisons are typically complex and difficult to obtain due to the nature of the broadband service links between a network's core and a building or a premise. One problem for providers of broadband service links stems from requirements to connect different types of communication equipment using multiple protocol conversions and communication link conversions. Typically, conversions are a large source of expense for ILECs, CLECs and Service Providers.

For example, a broadband service link between a network's core and a building or premise may consist of three communication segments (fiber-wireless-fiber) each with multiple protocol and communication link conversions. At the network core, a SONET/SDH fiber may be connected to ATM communication equipment that performs add-drop-mux (ADM) functions in accordance with a SONET/SDH protocol. Line cards within the ATM communication equipment aggregate, switch and convert traffic to other protocols such as Ethernet, which are used across fiber distribution links such as Gigabit Ethernet (GbE). The fiber distribution links are connected to other communication equipment that perform wireless base-station functions that may include yet another protocol conversion to support the broadband wireless access (BWA) protocol in-use. The broadband service link propagates over the air. A wireless terminal terminates the BWA protocol in-use and converts back to an Ethernet or SONET/SDH protocol. The wireless terminal distributes broadband services across fiber links to a network terminal equipment residing at a building or premise. In this example, the broadband service link undergoes multiple protocol conversions and communication link conversions between the network's core and a premise.

### SUMMARY OF THE INVENTION

In general, in one aspect, the invention includes a converter including an optical fiber input port; an optical detector configured to receive an optical signal over the optical fiber input port and generate a first electrical signal carrying information; and a mixer in electrical communication with the optical detector configured to mix the first electrical signal with a radio frequency carrier wave producing a second electrical signal for transmission by an antenna. The second electrical signal carries the same information as the first electrical signal.

Aspects of the invention may include one or more of the following features. The converter further includes a linear filter for filtering the first electrical signal. The converter further includes a linear filter for filtering the second electrical signal. The optical fiber input port is in optical communication with a first node in a passive optical network and the antenna is in electromagnetic communication with a second node in a passive optical network. The information includes overhead data according to a PON protocol. The information includes payload data coded to be transmitted in an optical system. The second electrical signal carries a same sequence of modulation symbols as the first electrical signal.

In general, in another aspect, the invention includes a method for converting signals including receiving an optical signal over an optical fiber input port and generating a first electrical signal carrying information; and mixing the first electrical signal with a radio frequency carrier wave producing a second electrical signal for transmission by an antenna. The second electrical signal carries the same information as the first electrical signal.

In general, in another aspect, the invention includes a converter including an antenna configured to receive a radio frequency signal; a mixer configured to down-convert a received radio frequency signal to a baseband electrical signal carrying information; and a laser driver in electrical communication with the mixer configured to modulate an optical signal with the baseband electrical signal producing a modulated optical signal for transmission over an optical fiber link. The modulated optical signal carries the same information as the baseband electrical signal.

Aspects of the invention may include one or more of the following features. The converter includes a linear filter for filtering the radio frequency signal. The converter includes a linear filter for filtering the baseband electrical signal. The optical fiber input port is in optical communication with a first node in a passive optical network and the antenna is in electromagnetic communication with a second node in a passive optical network. The information includes overhead data according to a PON protocol. The information includes payload data coded to be transmitted in an optical system. The modulated optical signal carries a same sequence of modulation symbols as the baseband electrical signal.

In general, in another aspect, the invention includes a method for converting signals including receiving a radio frequency signal; down-converting the received radio frequency signal to a baseband electrical signal carrying information; and modulating an optical signal with the baseband electrical signal producing a modulated optical signal for transmission over an optical fiber link. The modulated optical signal carries the same information as the baseband electrical signal.

In general, in another aspect, the invention includes a converter including an optical fiber input port; an optical detector configured to receive an optical signal over the optical fiber input port and generate a first electrical signal carrying information; a first mixer in electrical communication with the optical detector configured to mix the first electrical signal with a radio frequency carrier wave producing a second electrical signal for transmission by an antenna; an antenna configured to receive a radio frequency signal; a second mixer configured to down-convert a received radio frequency signal to a baseband electrical signal carrying information; and a laser driver in electrical communication with the second mixer configured to modulate an optical signal with the baseband electrical signal producing a modulated optical signal for transmission over an optical fiber link. The modulated optical signal carries the same information as the baseband electrical signal. The second electrical signal carries the same information as the first electrical signal.

Aspects of the invention may include one or more of the following features. The optical fiber input port is in optical communication with a first node in a passive optical network and the antenna is in electromagnetic communication with a second node in a passive optical network. The information in the first electrical signal and the information in the baseband electrical signal include overhead data according to a PON protocol. The information in the first electrical signal and the information in the baseband electrical signal include payload data coded to be transmitted in an optical system. The modulated optical signal carries a same sequence of modulation symbols as the baseband electrical signal and the second electrical signal carries a same sequence of modulation symbols as the first electrical signal.

In general, in another aspect, the invention includes a method for converting signals including receiving an optical signal over an optical fiber input port and generating a first electrical signal carrying information; mixing the first electrical signal with a radio frequency carrier wave producing a second electrical signal for transmission by an antenna; receiving a radio frequency signal; down-converting the received radio frequency signal to a baseband electrical signal carrying information; and modulating an optical signal with the baseband electrical signal producing a modulated optical signal for transmission over an optical fiber link. The modulated optical signal carries the same information as the baseband electrical signal. The second electrical signal carries the same information as the first electrical signal.

In general, in another aspect, the invention includes a link in a passive optical network, including a first converter configured to convert an input optical signal carrying information into a radio frequency signal for transmission by a first antenna; and a second converter configured to receive a radio signal transmitted from the first converter and convert the received radio signal into an output optical signal carrying the same information as the input optical signal.

Aspects of the invention may include one or more of the following features. The information includes overhead data according to a PON protocol. The information includes payload data coded to be transmitted in an optical system. The output optical signal carries a same sequence of modulation symbols as the input optical signal. The second converter is further configured to convert a second input optical signal carrying information into a second radio frequency signal for transmission by a second antenna. The first converter is further configured to receive the second radio frequency signal transmitted from the second converter and convert the received radio frequency signal into a second output optical signal carrying the same information as the second input optical signal.

In general, in another aspect, the invention includes a method including converting an input optical signal carrying information into a radio frequency signal for transmission by a first antenna; and receiving a radio signal transmitted from the first converter and convert the received radio signal into an output optical signal carrying the same information as the input optical signal.

In general, in another aspect, the invention includes a passive optical network, including a first node in the network; a passive optical splitter in communication with the first node over a first optical fiber link; a second node in communication with the passive optical splitter over a second optical fiber link; and a third node in communication with the passive optical splitter over a link that includes a radio frequency link.

Aspects of the invention may include one or more of the following features. The first node comprises an optical line terminator. The second node comprises an optical networking device. The third node comprises an optical networking device. The radio frequency link uses a same communication protocol as the first and second optical fiber links.

In general, in another aspect, the invention includes a method for transmitting data over an optical network, the method including formatting a data stream according to an optical communication protocol; transmitting the formatted data stream as an optical signal from a first node in the optical network; receiving the transmitted optical signal at a second node in the optical network; converting the received optical signal to a radio frequency signal without changing the formatting of formatted data stream; transmitting the radio frequency signal from the second node to a third node in the optical network; receiving the radio frequency signal at the third node; converting the received radio frequency signal to an optical signal; and transmitting the converted optical signal over an optical link.

Aspects of the invention may include one or more of the following features. The data stream includes coding the data stream. Formatting the data stream includes representing information in the data stream as a sequence of symbols.

In general, in another aspect, the invention includes a method for distributing a signal in a passive optical network, including transmitting an optical signal for distribution in the passive optical network; splitting the optical signal for distribution to two or more nodes in the passive optical network; coupling the optical signal to a first node over an optical fiber link; and coupling the optical signal to a second node over a radio frequency link.

Aspects of the invention may include formatting a data stream for transmission in the optical signal.

Implementations of the invention may include one or more of the following advantages.

PONs conventionally have a limit to the number of clients and a limit to the maximum distance (or reach) from an Optical Line Terminator (OLT) and a client Optical Network Unit (ONU) or Optical Network Terminal (ONT). This limit is primarily a function of optical power loss. An increase in the number of clients may lead to an increase in the number of splits in the fiber network and a decrease in the received optical power for the receivers of both OLT and client ONU/ONTs. Likewise, an increase in the maximum distance between an OLT and an ONU/ONT client may lead to a decrease in received optical power for the receivers of both OLT and ONU/ONT clients, the reduced optical power substantially reducing the number of clients the network is capable of supporting with a given optical power loss budget. Typically, a design trade off exists between number of clients and maximum reach. Augmenting an Optical Distribution Network (ODN) of a PON with wireless links may influence this design tradeoff.

### BRIEF DESCRIPTION OF THE DRAWINGS

FIG. 1 is a block diagram of a passive optical network (PON).

FIG. 2 is a block diagram of an optical receiver and radio frequency transmitter converter.

FIG. 3 is a block diagram of a radio frequency receiver and an optical transmitter converter.

FIG. 4 is a block diagram of a bi-directional radio optical transceiver converter.

FIG. 5 is a block diagram of a point-to-multipoint passive optical network system.

### DETAILED DESCRIPTION

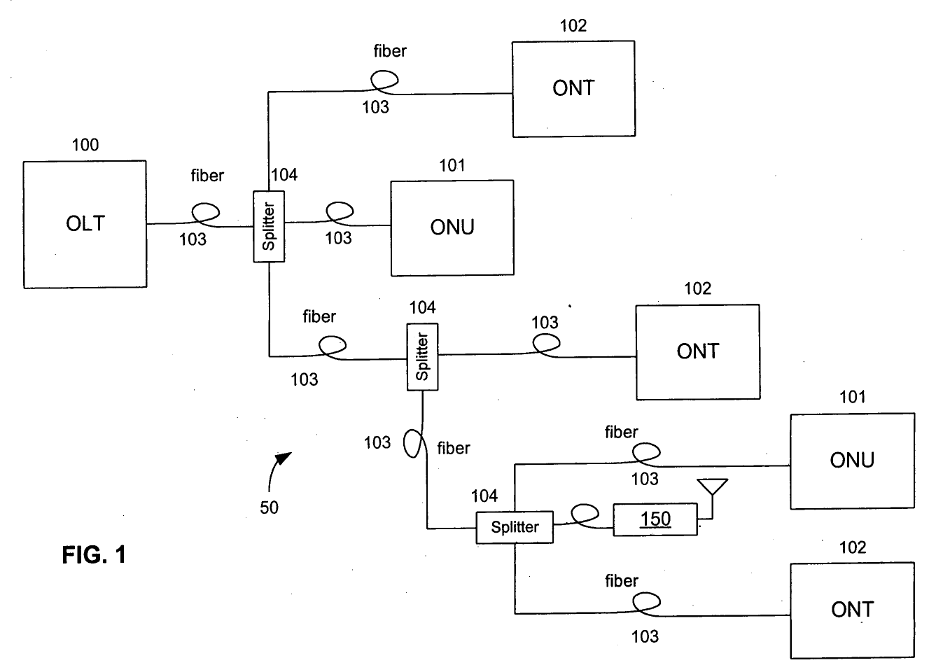

Passive Optical Network (PON) links can be augmented to use radio frequency communications. A PON can be configured in a point-to-multipoint fiber optic network in a tree-branch network architecture. FIG. 1 shows an example of a PON, where an Optical Line Terminator (OLT) 100 provides broadband communication to a plurality of client optical networking devices, including Optical Network Units (ONUs) 101 and Optical Network Terminals (ONTs) 102, at nodes in an Optical Distribution Network (ODN) 50. ODN 50 includes optical fibers 103, splitters 104, splices (not shown) and connectors (not shown) between an OLT 100 node and ONU 101 and ONT 102 nodes. Any of a variety of PON implementations may be used including implementations according to the ITU G.983, G.984 and IEEE 802.3ah specifications, which are hereby incorporated by reference, or a derivative thereof.

In general, the role of an OLT 100 is to control information traffic between the OLT 100 and client ONUs 101 and ONTs 102 while interfacing with network service entities (not shown) to provide broadband service links across a PON. Each ONU 101 responds to the OLT's 100 control while passing information between the OLT 100 and network service interfaces (not shown) thereby allowing other broadband service links to be connected to a respective ONU 101. ONTs 102 respond to an OLT's 100 control while terminating broadband service links between the OLT 100 and a user network interface (not shown), which is connected to the ONT 102.

PON links can be augmented to include a converter 150 at an intermediate node to receive optical fiber signals that are then transmitted as radio frequency signals and/or to receive radio frequency signals that are then transmitted as optical fiber signals. Converter 150 uses an optical communication protocol (e.g., a PON communication protocol), and no conversion of the received signals (other than optical to electrical and electrical to optical) is required. Accordingly, PON 50 is able to use an optical communication protocol for both optical links and links that include radio frequency links. PON 50 can use an RF link to extend an ODN without necessarily requiring the expense or complexity of stages to perform such functions as frame synchronization, decoding or re-coding of signals in accordance with an RF protocol. Instead, electrical signals associated with a received or transmitted optical signal and electrical signals associated with received or transmitted radio frequency signals can carry the same information. For example, payload data can remain coded according to a coding technique that is optimized for optical links. Overhead data associated with an optical communication protocol (e.g., data link layer framing overhead) can remain the same.

The electrical signals and the associated radio frequency and/or optical signals can also represent a same “baseband signal” with a same sequence of modulation symbols without requiring reformatting. Formatting, as used herein, refers to a process of preparing a baseband signal from an input data stream for transmission over the PON. Formatting includes coding, framing, filtering, etc. Various overhead bits (overhead data) may be added to the input data stream (payload data) in accordance with the formatting process. Formatting also includes preparation of a sequence of modulation symbols yielding a baseband signal to represent the information in the signal.

Modulation, as used herein, refers to the process of mixing a formatted baseband signal with a carrier, either optical or radio frequency. In some implementations, a baseband and/or modulated signal and its modulation symbols may be amplified, reshaped, retimed, regenerated, and/or filtered.

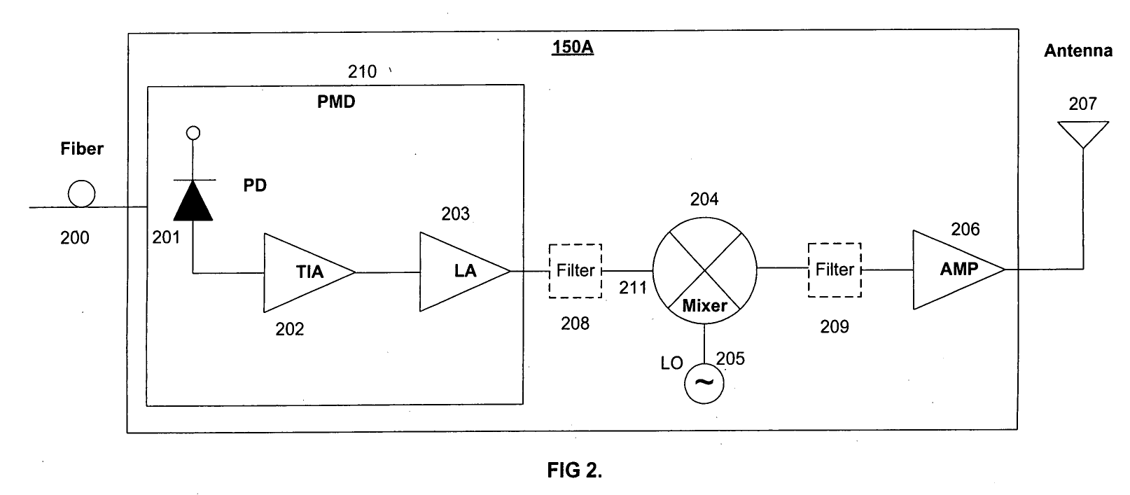

FIG. 2 shows one implementation of a converter 150A that converts optical fiber signals to radio frequency signals. Input optical fiber signals are received over an optical fiber 200. An optical receiver 210 includes a photo detector (PD) 201 that converts the light transmitted over the fiber 200 into an electrical current. A transimpedance amplifier (TIA) 202 converts changes in input current to changes in output voltage. The TIA 202 takes the current input from the PD 201 and converts the current to a voltage. The voltage is input into a linear amplifier (LA) 203. The LA 203 provides voltage gain on, what is typically, the relatively weak signal generated by the PD 201 and TIA 202. The voltage is then input into a Mixer 204 that takes as input a Local Oscillator (LO) signal 205 and a Reference signal 211. The mixer 204 modulates the reference 211 input with the LO signal 205 and generates an output signal whose frequency is the sum of the frequencies of the two input signals. The LO frequency 205 is a carrier signal meant to raise the center frequency of the reference signal 211 to a frequency suitable for radio transmission. The effect is that the reference signal 211 is up-shifted about the frequency of the LO signal 205 input. The output of the mixer 204 can then be input to an amplifier (Amp) 206. Amp 206 provides sufficient power for radio frequency transmission with the Antenna 207. Filters 208 and 209 may optionally be included to improve performance of the mixer 204. The mixer 204 may optionally include intermediate frequency stages. Alternatively, the optical receiver 210 can include other types of receivers that generate an electrical signal from an optical signal.

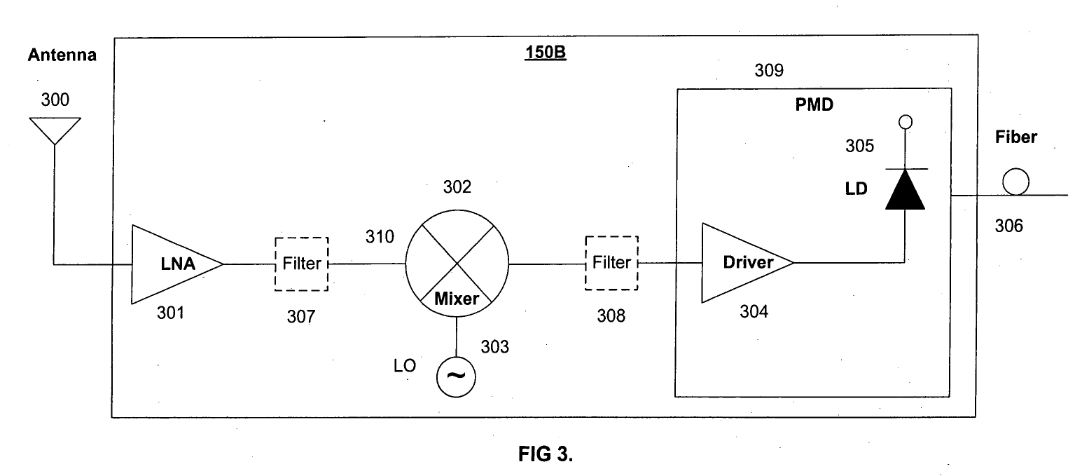

FIG. 3 shows an alternative implementation of a converter 150B that converts received radio frequency signals to optical fiber signals. Input radio frequency signals are received by antenna 300. A low noise amplifier (LNA) 301 provides amplification to the signal produced by the antenna 300 without adding significant noise. A mixer 302 mixes a local oscillator LO signal 303 and reference signal 310 and generates an output signal whose frequency is the difference of the frequencies of the two input signals. The mixer 302 down-converts the input from the LNA 301 producing a representation of the received radio frequency signal without the carrier. The output of the mixer 302 is provided as an input to a laser driver (Driver) 304 of an optical transmitter 309. The laser driver 304 provides modulated current based on its input to a laser diode (LD) 305. The LD 305 creates light transmission based on input from the laser driver 304. For burst mode optical transmissions, the driver 304 may or may not provide current to the LD 305 when no radio transmissions are received. The light transmission is then provided to a fiber 306 that facilitates transmission of the communication received from the antenna 300. Filters 307 and 308 may optionally be included to improve performance of the mixer 302. The mixer 302 may optionally include intermediate frequency stages. Alternatively, the optical transmitter 309 can include other types of transmitters that generate an optical signal from an electrical signal.

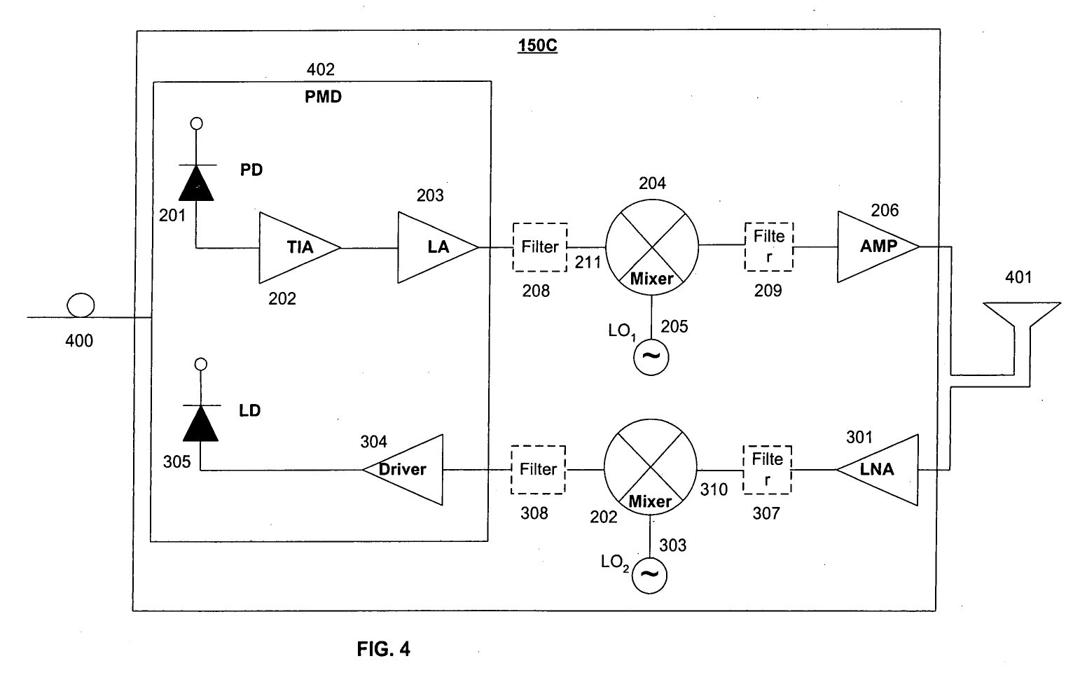

Both conversion processes of the converter 150A and of the converter 150B can be combined to enable bi-directional communications. An exemplary bi-directional converter 150C is shown in FIG. 4. The mixers 204,302 have local oscillators LO₁ 205 and L0₂ 303 that may or may not have the same frequency. When appropriate different frequencies are used, bidirectional communication can be made without other considerations. If a same frequency is used in each LO 205, 303, then other techniques include different polarizations for transmitted rf fields or time division multiplexing may be used. The fiber link 400 may include a bi-directional fiber and/or multiple unidirectional fibers. The rf transceiver 401 may include one or more antennas. The optical transceiver 402 can use any of a variety of optical/electrical conversion techniques.

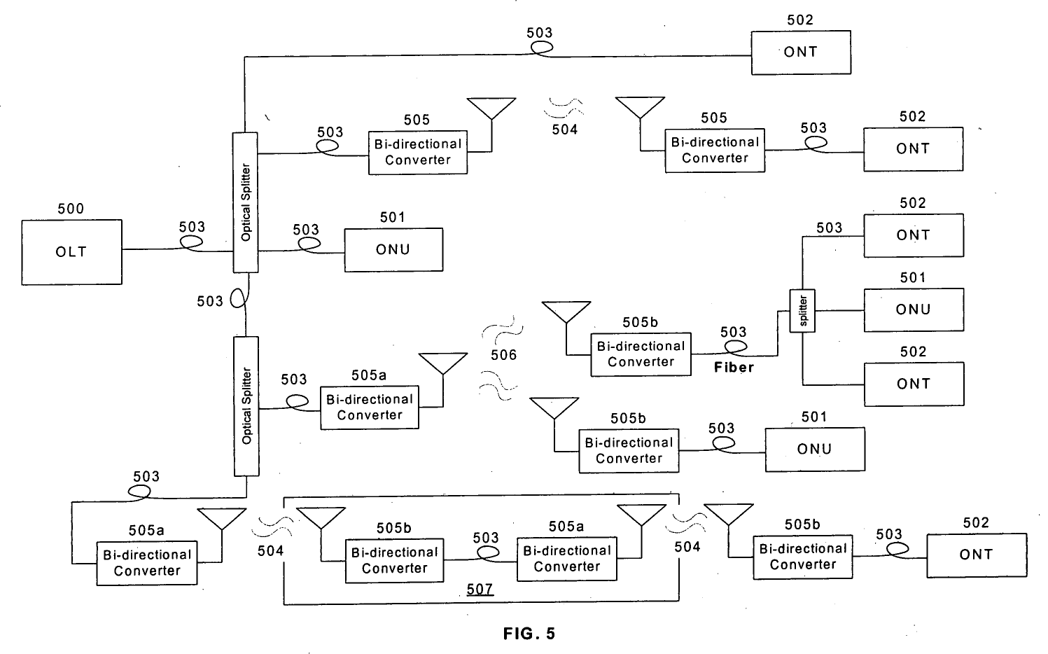

FIG. 5 is a block diagram of a point-to-multipoint passive optical network system with augmented radio frequency links. The PON system includes an OLT 500 with ONUs 501 and ONTs 502 connected across fibers 503 and wireless links 504 provided by bi-directional converters 505a, 505b. The bi-directional converters 505a, 505b may use different frequencies to transmit data between the OLT 500, ONU 501 and ONT 502 in which case the LO input of the corresponding mixers will be different to match the corresponding transmit and receive frequencies. The ONUs 501 and ONTs 502 may be connected to the OLT 500 by a fiber link 503. The ONUs 501 and ONTs 502 may be connected to the OLT 500 by a combination of fiber and a wireless link 504 using bi-directional converters 505a, 505b. Multiple ONUs 501 and ONTs 502 may be connected to an OLT 500 by individual point-to-point wireless links (e.g., links 504) or by point-to-multipoint wireless links (e.g., link 506 where a bi-directional converter 505a supports a plurality of bi-directional converters 505b). Additionally, the ONUs 501 and ONTs 502 may be connected to the OLT 500 by multiple wireless links 504. For example, in such a connection, a bi-directional converter 505b is connected to another bi-directional converter 505a by fiber link 503 as shown for module 507. Alternative point-to-multipoint fiber optic network configurations with augmented wireless links may be used.

As previously mentioned, a derivative specification may be used to implement the PON 50. Derivative specifications may take into account increased communication delays because of the wireless links 504 as well as an increase in the number of ONU/ONT clients supported by the PON 50 as compared to conventional PON network specifications.

Although the invention has been described in terms of particular implementations, one of ordinary skill in the art, in light of this teaching, can generate additional implementations and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

1. A converter comprising:
an optical fiber input port;
an optical detector configured to receive an optical signal over the optical fiber input port and generate a first electrical signal carrying information; and
a mixer in electrical communication with the optical detector configured to mix the first electrical signal with a radio frequency carrier wave producing a second electrical signal for transmission by an antenna;
wherein the second electrical signal carries the same information as the first electrical signal.

2. The converter of claim 1, further comprising a linear filter for filtering the first electrical signal.

3. The converter of claim 1, further comprising a linear filter for filtering the second electrical signal.

4. The converter of claim 1, wherein the optical fiber input port is in optical communication with a first node in a passive optical network and the antenna is in electromagnetic communication with a second node in a passive optical network.

5. The converter of claim 1, wherein the information includes overhead data according to a PON protocol.

6. The converter of claim 1, wherein the information includes payload data coded to be transmitted in an optical system.

7. The converter of claim 1, wherein the second electrical signal carries a same sequence of modulation symbols as the first electrical signal.

8. A method for converting signals comprising:
receiving an optical signal over an optical fiber input port and generating a first electrical signal carrying information; and
mixing the first electrical signal with a radio frequency carrier wave producing a second electrical signal for transmission by an antenna;
wherein the second electrical signal carries the same information as the first electrical signal.

9. A converter comprising:
an antenna configured to receive a radio frequency signal;
a mixer configured to down-convert a received radio frequency signal to a baseband electrical signal carrying information; and
a laser driver in electrical communication with the mixer configured to modulate an optical signal with the baseband electrical signal producing a modulated optical signal for transmission over an optical fiber link;
wherein the modulated optical signal carries the same information as the baseband electrical signal.

10. The converter of claim 9, further comprising a linear filter for filtering the radio frequency signal.

11. The converter of claim 9, further comprising a linear filter for filtering the baseband electrical signal.

12. The converter of claim 9, wherein the optical fiber input port is in optical communication with a first node in a passive optical network and the antenna is in electromagnetic communication with a second node in a passive optical network.

13. The converter of claim 9, wherein the information includes overhead data according to a PON protocol.

14. The converter of claim 9, wherein the information includes payload data coded to be transmitted in an optical system.

15. The converter of claim 9, wherein the modulated optical signal carries a same sequence of modulation symbols as the baseband electrical signal.

16. A method for converting signals comprising:
receiving a radio frequency signal;
down-converting the received radio frequency signal to a baseband electrical signal carrying information; and
modulating an optical signal with the baseband electrical signal producing a modulated optical signal for transmission over an optical fiber link;
wherein the modulated optical signal carries the same information as the baseband electrical signal.

17. A converter comprising:
an optical fiber input port;
an optical detector configured to receive an optical signal over the optical fiber input port and generate a first electrical signal carrying information;
a first mixer in electrical communication with the optical detector configured to mix the first electrical signal with a radio frequency carrier wave producing a second electrical signal for transmission by an antenna;
an antenna configured to receive a radio frequency signal;
a second mixer configured to down-convert a received radio frequency signal to a baseband electrical signal carrying information; and
a laser driver in electrical communication with the second mixer configured to modulate an optical signal with the baseband electrical signal producing a modulated optical signal for transmission over an optical fiber link;
wherein the modulated optical signal carries the same information as the baseband electrical signal; and
wherein the second electrical signal carries the same information as the first electrical signal.

18. The converter of claim 17, wherein the optical fiber input port is in optical communication with a first node in a passive optical network and the antenna is in electromagnetic communication with a second node in a passive optical network.

19. The converter of claim 17, wherein the information in the first electrical signal and the information in the baseband electrical signal include overhead data according to a PON protocol.

20. The converter of claim 17, wherein the information in the first electrical signal and the information in the baseband electrical signal include payload data coded to be transmitted in an optical system.

21. The converter of claim 17, wherein the modulated optical signal carries a same sequence of modulation symbols as the baseband electrical signal and the second electrical signal carries a same sequence of modulation symbols as the first electrical signal.

22. A method for converting signals comprising:
receiving an optical signal over an optical fiber input port and generating a first electrical signal carrying information;
mixing the first electrical signal with a radio frequency carrier wave producing a second electrical signal for transmission by an antenna;
receiving a radio frequency signal;
down-converting the received radio frequency signal to a baseband electrical signal carrying information; and
modulating an optical signal with the baseband electrical signal producing a modulated optical signal for transmission over an optical fiber link;
wherein the modulated optical signal carries the same information as the baseband electrical signal; and
wherein the second electrical signal carries the same information as the first electrical signal.

23. A link in a passive optical network, comprising:
a first converter configured to convert an input optical signal carrying information into a radio frequency signal for transmission by a first antenna; and
a second converter configured to receive a radio signal transmitted from the first converter and convert the received radio signal into an output optical signal carrying the same information as the input optical signal.

24. The link of claim 23, wherein the information includes overhead data according to a PON protocol.

25. The link of claim 23, wherein the information includes payload data coded to be transmitted in an optical system.

26. The link of claim 23, wherein the output optical signal carries a same sequence of modulation symbols as the input optical signal.

27. The link of claim 23, wherein
the second converter is further configured to convert a second input optical signal carrying information into a second radio frequency signal for transmission by a second antenna; and
the first converter is further configured to receive the second radio frequency signal transmitted from the second converter and convert the received radio frequency signal into a second output optical signal carrying the same information as the second input optical signal.

28. A method comprising:
converting an input optical signal carrying information into a radio frequency signal for transmission by a first antenna; and
receiving a radio signal transmitted from the first converter and convert the received radio signal into an output optical signal carrying the same information as the input optical signal.

29. A passive optical network, comprising:
a first node in the network;
a passive optical splitter in communication with the first node over a first optical fiber link;
a second node in communication with the passive optical splitter over a second optical fiber link; and
a third node in communication with the passive optical splitter over a link that includes a radio frequency link.

30. The passive optical network of claim 29, wherein the first node comprises an optical line terminator.

31. The passive optical network of claim 29, wherein the second node comprises an optical networking device.

32. The passive optical network of claim 29, wherein the third node comprises an optical networking device.

33. The passive optical network of claim 29, wherein the radio frequency link uses a same communication protocol as the first and second optical fiber links.

34. A method for transmitting data over an optical network, the method comprising:
formatting a data stream according to an optical communication protocol;
transmitting the formatted data stream as an optical signal from a first node in the optical network;
receiving the transmitted optical signal at a second node in the optical network;
converting the received optical signal to a radio frequency signal without changing the formatting of formatted data stream;
transmitting the radio frequency signal from the second node to a third node in the optical network;
receiving the radio frequency signal at the third node;
converting the received radio frequency signal to an optical signal; and
transmitting the converted optical signal over an optical link.

35. The method of claim 34, wherein formatting the data stream includes coding the data stream.

36. The method of claim 34, wherein formatting the data stream includes representing information in the data stream as a sequence of symbols.

37. A method for distributing a signal in a passive optical network, comprising:
transmitting an optical signal for distribution in the passive optical network;
splitting the optical signal for distribution to two or more nodes in the passive optical network;
coupling the optical signal to a first node over an optical fiber link; and
coupling the optical signal to a second node over a radio frequency link.

38. The method of claim 37, further comprising formatting a data stream for transmission in the optical signal.
